(19) United States
(12) Patent Application Publication
(10) Pub. No.: US 2026/0247460 A1
(43) Pub. Date: Aug. 20, 2026

(54) METHODS, ARCHITECTURES, APPARATUSES AND SYSTEMS FOR INITIATING A NETWORK INITIATED REGISTRATION PROCEDURE

(71) Applicant: InterDigital Patent Holdings, Inc., Wilmington, DE (US)

(72) Inventors: Ulises Olvera-Hernandez, Saint-Lazare (CA); Taimoor Abbas, Sainte-Julie (CA); Michael Starsinic, Newtown, PA (US); Michel Roy, Candiac (CA); Samir Ferdi, Kirkland (CA); Achref Methenni, Montreal (CA); Saad Ahmad, Montreal (CA)

(21) Appl. No.: 19/056,556

(22) Filed: Feb. 18, 2025

(51) Int. Cl. H04W 76/15; H04W 8/22; H04W 48/18; H04W 60/04

(52) U.S. Cl. CPC H04W 76/15; H04W 8/22; H04W 48/18; H04W 60/04

(57) ABSTRACT

This disclosure is related to initiating a network initiated registration procedure. A wireless transmit/receive unit (WTRU) is configured to transmit, to a wireless network, a first information indicating a capability to sponsor one or more other WTRUs that are not registered with a mobile operator network (MNO). The WTRU may receive security credentials associated with one or more virtual context identifiers. The WTRU may transmit a second information. The wireless network may be configured to initiate a registration procedure, based on the second information. The WTRU may receive, from the wireless network, third information. The WTRU may communicate with the one or more other WTRUs using the wireless network, based on the third information and on a policy of the MNO.

### TECHNICAL FIELD

The present disclosure is generally directed to the fields of communications, software and encoding, including, for example, to methods, architectures, apparatuses, systems related to initiating a network initiated registration procedure.

### SUMMARY

In accordance with certain representative embodiments of the present disclosure, methods and systems are provided for initiating a network initiated registration procedure. In certain representative embodiments, a wireless transmit/receive unit (WTRU) is configured to transmit, to a wireless network, a first information indicating a capability to sponsor one or more other WTRUs that are not registered with a mobile operator network (MNO). The WTRU may receive, from the wireless network, security credentials associated with one or more virtual context identifiers. The WTRU may transmit, to the wireless network, second information. The second information may indicate information identifying the one or more other WTRUs that are not registered with the MNO, information identifying one or more application identifiers associated with the one or more other WTRUs, a data network identifier, and single-network slice selection assistance information (S-NSSAI). The wireless network may be configured to initiate a WTRU sponsoring configuration procedure, based on the second information. The WTRU may receive, from the wireless network, third information comprising an indication that indicates that a packet data unit (PDU) session was established, one or more virtual context identifiers, and information identifying the one or more other WTRUs which the MNO authorized to be sponsored. The WTRU may communicate with the one or more other WTRUs using the wireless network, based on the third information and on a policy of the MNO.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A shows a system diagram illustrating an example communications system, according to one or more embodiments of this disclosure;

FIG. 1B shows a system diagram illustrating an example wireless transmit/receive unit (WTRU) that may be used within the communications system illustrated in FIG. 1A, according to one or more embodiments of this disclosure;

FIG. 1C shows a system diagram illustrating an example radio access network (RAN) and an example core network (CN) that may be used within the communications system illustrated in FIG. 1A, according to one or more embodiments of this disclosure;

FIG. 1D shows a system diagram illustrating a further example RAN and a further example CN that may be used within the communications system illustrated in FIG. 1A, according to one or more embodiments of this disclosure;

FIG. 2 shows a scenario illustrating manual roaming in cellular networks, according to one or more embodiments of this disclosure;

FIG. 3 is a diagram illustrating a packet processing procedure at a user plane function, according to one or more embodiments of this disclosure;

FIG. 4 is a flowchart of illustrative steps for delivering services to unregistered WTRUs, according to one or more embodiments of this disclosure;

FIG. 5 is a diagram of illustrative steps for a service sponsoring request triggered by an application service provider, according to one or more embodiments of this disclosure;

FIG. 6 is a diagram of illustrative steps for a calling party initiated sponsor request procedure, according to one or more embodiments of this disclosure;

FIG. 7 is a diagram of illustrative steps for a registration procedure triggered by a network entity receiving downlink data, according to one or more embodiments of this disclosure;

FIG. 8 is a diagram of illustrative steps for a registration procedure triggered by a calling party, according to one or more embodiments of this disclosure; and

FIG. 9 is a flowchart of illustrative steps for a service sponsorship procedure initiated by a calling party for one or more WTRUs which are not registered with a particular MNO, according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

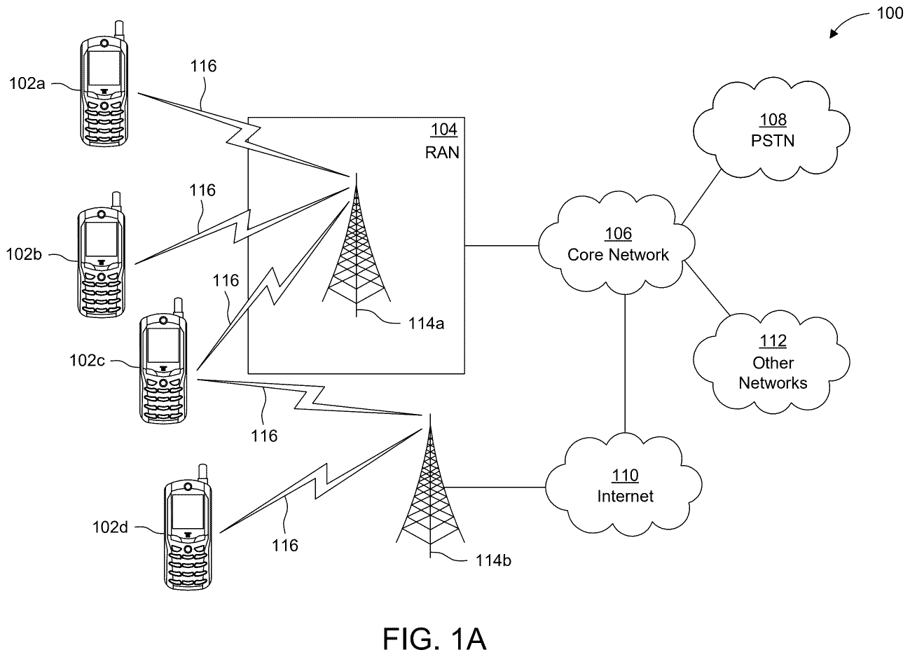

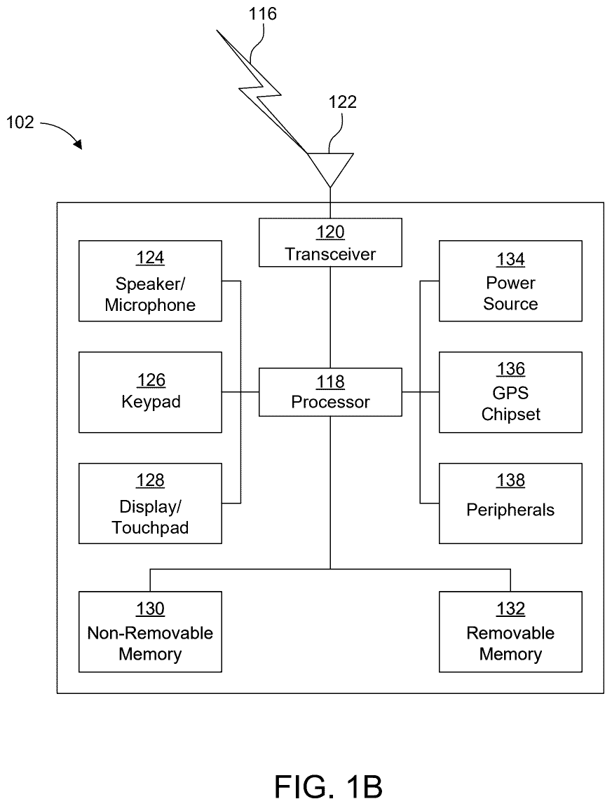

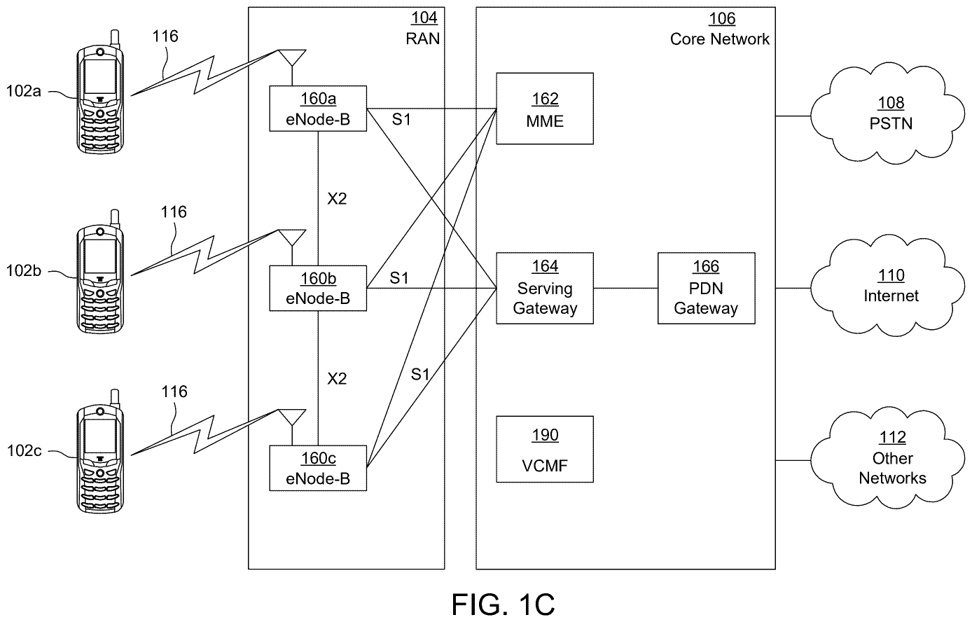

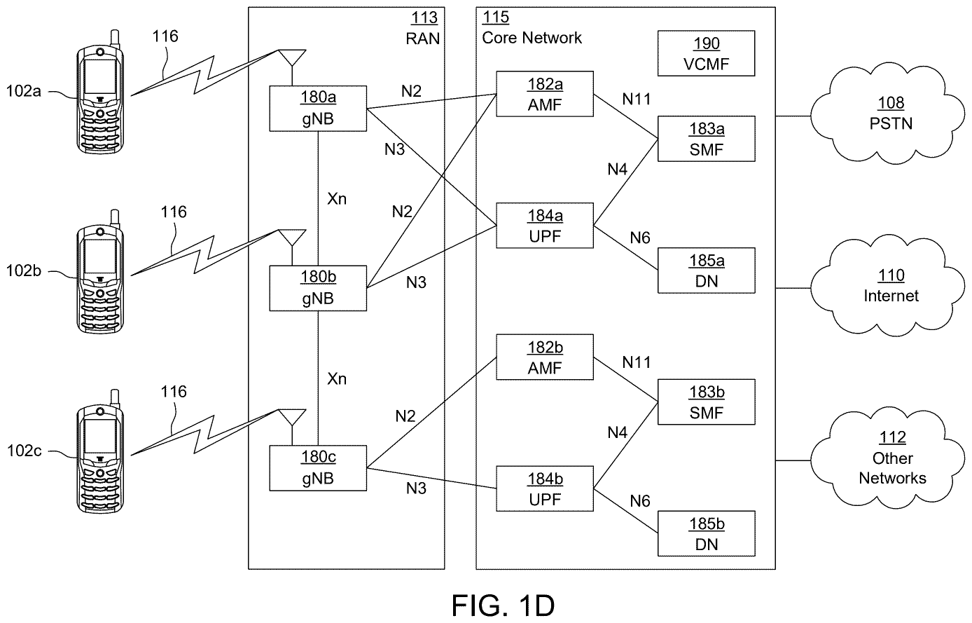

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, if that WTRU includes only one active UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, a packet data network (PDN) gateway (PGW) 166, and a virtual context management function (VCMF) 190. While each of the foregoing elements are depicted as part of the CN 106, it will be appreciated that any one of these elements may be owned and/or operated by an entity other than the CN operator.

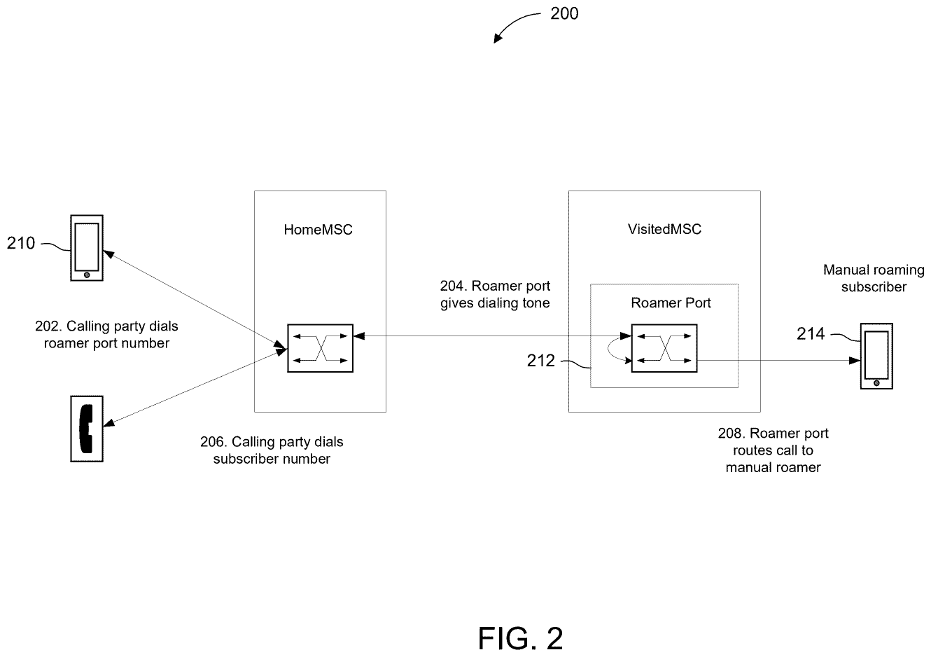

VCMF 190 may be configured to provide functionality within a wireless network for any aspect related to virtual context as described herein. That is, any feature or aspect described herein related to virtual context may be provided with respect to a wireless network by virtue of VCMF 190. For example, VCMF 190 may store data which enables a wireless network to maintain sufficient information to initiate a network initiated registration procedure for WTRUs which are not registered with respect to a mobile network operator (MNO) as described below in connection to FIGS. 2-9. While VCMF 190 is depicted as a distinct network function, it will be appreciated that the features and functionality provided by VCMF 190 may at least partially be implemented in one or more of the other network functions (e.g., AMF 182a-182b, SMF 183a-183b, and UPF 184a-184b).

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, and VCMF 190. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In accordance with one or more embodiments of this disclosure, the devices and systems of FIGS. 1A-1D may be used in connection with devices, systems, and methods for cell reselection. For example, the devices and systems of FIGS. 1A-1D may be used in connection with the devices, systems, and methods described in FIGS. 2-9, according to one or more embodiments of this disclosure.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network

In the context of this disclosure, the term “network initiated registration” (NIR), refers to a registration procedure which is initiated by a network entity within a cellular system to prompt a registration operation for an unregistered WTRU without the needing the unregistered WTRU to initiate the registration procedure. It will be understood that reference to a cellular system may also be a reference to a wireless network. A cellular system may initiate registration procedures for various reasons. For example, a cellular system may trigger the registration procedure by itself in an emergency situation which warrants certain WTRUs to be temporary registered to a network to deliver emergency notifications or to register low complexity devices in a particular area of interest. A cellular system may be prompted to trigger registration procedures for unregistered WTRUs.

In the context of this disclosure, the term “sponsored WTRU” refers to a WTRU which receives cellular services (e.g., data connectivity) in a cellular network such that the cost of receiving cellular services is assumed by a third party. It will be understood that a reference to a sponsored WTRU may also be a reference to an unregistered WTRU. The cellular system maintains relevant data which enables itself to handle NIRs. This relevant data is stored in a particular context referred to as “virtual context.” A “v-context” refers to a virtual context.

In the context of this disclosure, the term “v-context” term refers to the data set which enables a cellular system (e.g., a 6G Cellular system) to maintain sufficient information about a particular WTRU to initiate a registration procedure for unregistered WTRUs. Such information may include sponsoring data such as at least one of application service provider (ASP) IDs, calling party IDs (e.g., internet protocol (IP) addresses), available credit, allowed data volume, remaining service time, area of interest (e.g., geographical coordinates or other identifier such a tracking area (TA)), or and security credentials. Although a v-context may resemble a sponsored data connectivity profile in existing 5G architectures (i.e., sponsored data connectivity), the purpose and usage of these two concepts are not the same. The v-context is applied specifically to unregistered WTRUs, and it is used to enable NIR.

In the context of this disclosure, a PDU session-less single-network slice selection assistance information (S-NSSAI) or data network name (DNN) is a S-NSSAI or DNN identifying, respectively, a network slice or a data network associated with a WTRU. The WTRU may be registered on unregistered with the network and need not have an associated established PDU session.

In the context of this disclosure, a network instance may be defined to separate IP domains such as when a UPF is connected to 5G access networks (ANs) with different IP domains. There may be overlapping WTRU IP addresses assigned by multiple data networks or transport network isolation in the same public land mobile network (PLMN).

Registration procedures which enable WTRUs to access cellular systems have been in place from the introduction of cellular services. Typically, registering WTRUs are only able to register to their home systems, otherwise referred to as home mobile switching center (MSCs). Roaming agreements between different mobile network operators (MNOs) enabled WTRUs to register cooperating exchanges or visited MSCs, enabling mobile subscribers to utilize services across regions (e.g., spanning from states, provinces, countries, and continents). Operators offered both automatic roaming and manual roaming.

Automatic roaming enabled mobile subscribers to register with visited networks and automatically inform their home network that a subscriber was registered in a roaming partner system, enabling the home network to route mobile terminating calls to the visited exchange where its subscriber was located. With automatic roaming, subscribers were reached by calling parities using their usual cellular phone number, regardless of where the subscribers were roaming. Automatic roaming service incurred a high cost which roaming subscribers had to assume, and the cost was typically expensive.

Manual roaming was introduced as a way to make roaming more affordable, while supporting registration of roaming subscribers in a visited network, without enabling automatic routing of terminating calls to the roaming subscriber. With manual roaming, the visited network published roamer port numbers (RPNs) that a calling subscriber could use via a two-stage call. With this scheme, the calling party would call a number in the visited exchange, thereby paying the long-distance charges. Upon calling the RPN, the calling party would get a dialing tone and then the calling party would dial the regular subscriber directory number. The visited exchange would have known the manual roamer's number upon the initial registration and would then route the call to the appropriate location within the visited network.

FIG. 2 shows a scenario illustrating manual roaming in cellular networks, according to one or more embodiments of this disclosure. In scenario 200, at 202, calling party 210 dials an RPN. At 204, roamer port 212 gives a dialing tone. At 206, calling party 210 dials a subscriber number. At 208, roamer port 212 routes the call to manual roamer 214.

Current 5G cellular systems may enable the sponsoring of cellular services via the sponsor data connectivity feature. The policy control function (PCF) may authorize an application service provider (ASP) to request sponsored IP flows and authorize an ASP to request quality of service (QoS) resources based on a sponsored data connectivity profile from the unified data repository (UDR).

The PCF may use policy and charging control (PCC) rules to provide the SMF with information enabling the detection of a service data flow and policy and charging parameters specifying how the service data flow must be treated. PCC rules define the sponsoring of IP flows, and QoS resources, up to a limit given by the negotiated usage threshold agreed between an MNO and an ASP. For sponsored data connectivity, the PCF may receive a usage threshold from the application function (AF). If the AF specifies a usage threshold, then the PCF uses the sponsor identity to construct a monitoring key for monitoring volume, time, or both for user plane traffic and invoke usage monitoring at the SMF.

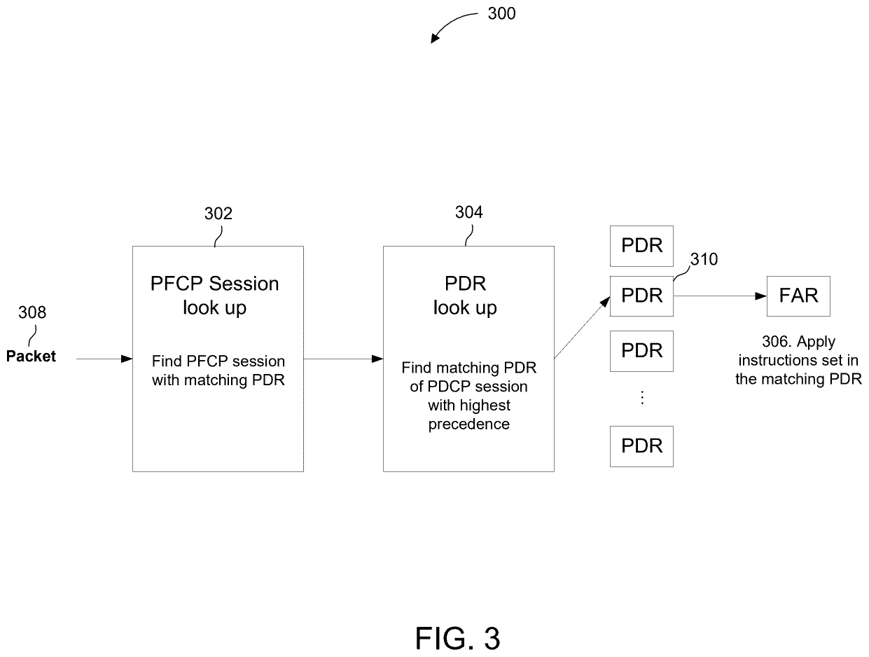

FIG. 3 is a diagram illustrating a packet processing procedure at a UPF, according to one or more embodiments of this disclosure. In diagram 300, at 302, a packet forwarding control protocol (PFCP) session look up occurs for packet 308. At 302, a UPF finds a PFCP session with a matching PDR. At 304, a UPF finds a matching PDR for a PFCP session with the highest precedence. At 304, matching PDR 310 is selected. At 306, a UPF applies the instruction set in matching PDR 310.

An SMF controls packet processing in 3 5G networks by establishing a PFCP session. A PFCP session is an association between the SMF and a UPF which handles the user plane path for PDU sessions. A PFCP session may handle traffic detection and packet forwarding. The SMF controls how the UPF detects traffic and forwards packets by configuring packet processing rules which may include at least one of packet detection rules (PDR), QoS enforcement, and usage reporting rules (URR). In addition, the SMF configures packet forwarding at the UPF by providing forwarding action rules (FARs) that specify how a packet should be treated based on the configured packet processing rules. The set of rules and packet forwarding actions are then maintained in as part of the PFCP session context. When a packet is received at the UPF, the UPF identifies the PFCP session to which the received packet corresponds and finds a PDR matching the characteristics of the incoming packet.

With reference to existing technological capabilities previously mentioned above, such as handling of manual roamers in former cellular networks and the possibility to sponsor data connectivity by a third party, it should be possible for subscribers that are under the coverage of a cellular system to be reached by a calling party (e.g., a third party). The calling party may be interested in contacting a subscriber such that the subscriber does not wish to register under a cellular system when registration to the cellular system may incur a charge. In such scenarios, the calling party (e.g., a sponsoring party), such an ASP, may be willing to assume cellular service charges for unregistered subscribers that are under the coverage of a cellular system.

To provide services for unregistered subscribers, a cellular system should be able to trigger a type of system registration procedure (e.g., a network initiated procedure) without relying on the unregistered WTRU to initiate such registration. Current 5G cellular systems do not support network initiated system registration for triggering unregistered WTRUs to perform initial registration.

It may be desirable to provide mechanisms and procedures to manage unregistered WTRUs. A wireless network entity may determine when and why an unregistered WTRU is under the radio coverage of a cellular network. The wireless network entity may determine whether the unregistered WTRU should be registered or prompted to register to the cellular network using a network-initiated procedure (without an initial attempt from the unregistered WTRU to register to the cellular network).

A wireless network entity (e.g., VCMF 190) may maintain WTRU-specific context information (e.g., in the form of a virtual, floating or dormant context) which enables the cellular system to identify unregistered subscribers under its coverage. The wireless network entity may use this WTRU-specific context information to deliver connectivity services to unregistered subscribers.

A wireless network entity may enable the sponsoring of connectivity services for unregistered subscribers (e.g., via an ASP or a calling party) willing to pay for services. The enablement of sponsoring connectivity services may be akin to delivering calls via collect-call procedures. A wireless network may enable ASPs or calling parties to configure WTRU-specific context information for unregistered WTRUs or subscribers by partnering with MNOs. A wireless network entity may enable the delivery of downlink (DL) data for unregistered WTRUs (i.e., WTRUs without existing PDU sessions) which may be identified through a virtual, floating or dormant context.

Delivery of DL data for unregistered subscribers (e.g., unregistered WTRUs), for WTRUs that do not have an established PDU session, or for WTRUs without any form to data connectivity to a wireless network may be enabled if the ingress node receiving mobile terminal (MT) data (e.g., a UPF or PDU session anchor node (PSA)) is able to detect traffic for these WTRUs (e.g., through the use of new PDRs). New PDRs may be defined using information provided through a floating, virtual or dormant context (hereafter referred to as v-context).

A v-context may store identifying information for one or more unregistered WTRUs such as at least one of a subscription permanent identifier (SUPI), mobile directory number, or other permanent identifier. Contact identifiers may include static IP address(s), IPv6 prefix(es), a MAC addresses, MAC address range, source IP addresses (of calling parties), fully qualified domain names (FQDNs), FQDN ranges, PDS Session-less S-NSSAI/DNN, a network access identifier(s), a session initiation protocol (SIP) address, or application identifier(s). The context information may also store security credentials that are associated with the SUPI, mobile directory number, or other permanent identifier.

The v-context may be populated in several ways. When a WTRU that supports v-context registers to a cellular system, the WTRU may indicate that is supports a v-context. A WTRU may provide information to assist the network build its v-context (e.g., the WTRU may provide its static IP address/IPv6 prefixes and IP address(s) from prospective calling-parties such as source IP address from calling parties).

In certain representative embodiments, an ASP may configure the v-context with a partnering MNO (e.g., by using new application influence on traffic routing mechanisms that may enable an ASP to sponsor cellular services for unregistered WTRUs that are using the ASP services or applications).

In certain representative embodiments, calling parties may configure v-context information in MNOs through a front-end portal where calling parties may register. Registration via a front-end portal allows the MNO to identify traffic coming from registered calling parties that are willing to sponsor non-registered subscribers (e.g., offering a virtual roamer port).

In certain representative embodiments, network data analytics may be used to enhance the accuracy of the data contained in the v-context via mobility analytics, WTRU communication analytics, or expected WTRU behavior analytics. The enhancement of the data in the v-context may aid in determining wake up patterns of unregistered WTRUs (e.g., by storing location and time information in the v-context). A network entity (e.g., a network data analytics function) may utilize long term historical data of a WTRU (e.g., available across other network entities such as a UPF, SMF, or PCF) to train a network analytics model such that the network analytics model may obtain WTRU behavior information. WTRU behavior information may include at least one of wake up patterns or probable locations during specific times for a particular WTRU. To enable the cellular system to enhance a v-context via network analytics for unregistered WTRUs, the cellular system (e.g., a PCF) may use permanent or temporary identifiers of WTRUs for which v-contexts are available. Similarly, a cellular system may utilize long term WTRU historical available across other network entities (e.g., the UPF, SMF or PCF) to train a network analytics model such that the network analytics model may obtain WTRU behavior information.

In certain representative embodiments, the detection of downlink traffic may trigger the network to initiate a network-initiated registration request (NIRR) using the context information from the v-context.

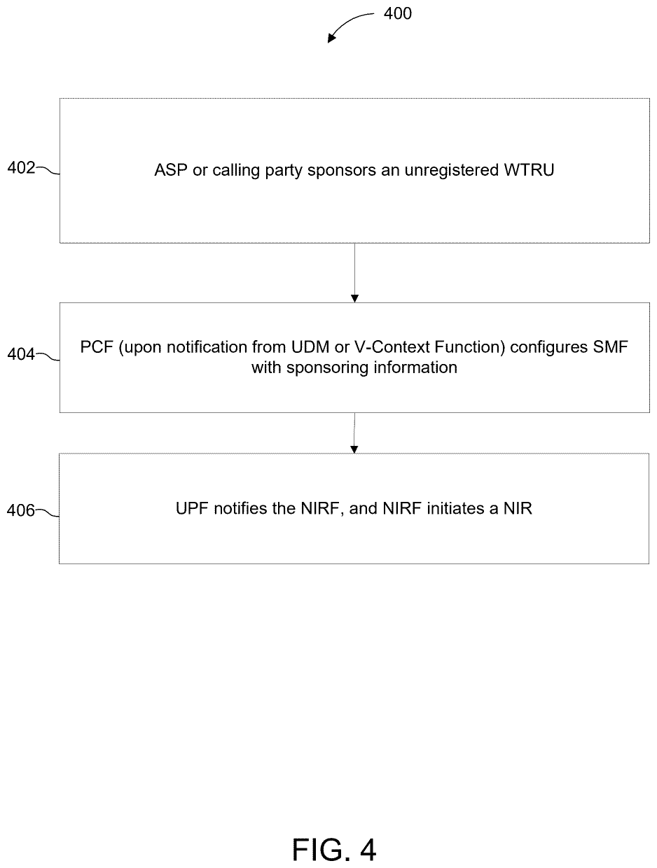

FIG. 4 is a flowchart of illustrative steps for delivering services to unregistered WTRUs, according to one or more embodiments of this disclosure. In diagram 400, at 402, an ASP or calling party sponsors an unregistered WTRU. An ASP or calling party may sponsor an unregistered WTRU by providing at least one of an area of interest, service duration (e.g., credit, data volume, or time), application IDs, or called or calling WTRU addressing identifiers. Information is stored in a v-context (e.g., at either the UDM or a VCMF).

At 404, a PCF (upon notification from UDM or VCMF) configures an SMF with sponsoring information. The SMF configures the UPF to detect traffic according to new v-context PDR rule.

At 406, a UPF (directly or via the SMF) upon detecting DL traffic for unregistered WTRUs, notifies an NIRF. The NIRF initiates an NIR using the v-context. A direct request from an ASP or calling party may also trigger an NIR.

In accordance with one or more embodiments of this disclosure, a calling-party WTRU may sponsor cellular services. A calling party WTRU (which may be referred to simply as a WTRU) may be configured to send an NAS message. The NAS message may be sent to an AMF or any suitable network entity. The NAS message may include information indicative of a WTRU's capability to sponsor one or more other WTRUs. The WTRU receives, from the wireless network, information including an indication that indicates, from the wireless network, security credentials associated with one or more virtual context identifiers.

The calling party WTRU may be configured to send another NAS message to a wireless network. The NAS message indicates to the wireless network that the WTRU intends to sponsor one or more WTRUs. The NAS message may be sent to the SMF, and the NAS message may include information indicative of a sponsoring S-NSSAI and a sponsoring DNN which may be used to request a sponsoring PDU session.

In certain representative embodiments, the WTRU configures a VCMF during the PDU session authentication procedure. The WTRU may provide identifying information (e.g., GSPIs or directory numbers) of the one or more WTRUs it intends to sponsor. The WTRU may provide authentication credentials that enable the VCMF to authenticate a sponsoring request.

In certain representative embodiments, the WTRU utilizes a v-context ID to determine whether the WTRU should use an ASP based sponsoring procedure to configure the sponsoring services. The WTRU may use user equipment route selection policy (URSP) rules to route UL traffic to a sponsoring PDU session when sending UL traffic intended for sponsored WTRUs. The WTRU may associate a stored v-context ID with a PDU session ID selected for the PDU session just established. The WTRU may use a v-context ID when attempting to reach (i.e., establish data connectivity) a sponsored/unregistered WTRU (e.g., if the PDU session originally used to configure the v-context no longer exists).

In accordance with one or more embodiments of this disclosure, network-initiated registration (NIR) may occur via an SMF (or any suitable network entity). The SMF may be configured with information such as a set of PDRs which a UPF (or other suitable network entity) may use to detect sponsor traffic. PDRs may include information indicative of a destination IP address of sponsored WTRUs, a network instance of the UPF where sponsored S-NSSAIs are defined, an application ID, or an originating IP address. The SMF may configure a UPF to determine when to notify the SMF based on actions and rules from a FAR. The SMF may configure a UPF to map a contact address that is in a DL packet to a v-context ID.

In certain representative embodiments, an SMF may determine that an NIR request is warranted. The SMF may issue an NIRR for a VCMF based on MNO policies and parameters identified by a network entity (e.g., a PSA). The SMF may determine the appropriate VCMF (e.g., by using the v-context ID, application ID, or querying the network repository function (NRF)). The SMF may determine a v-context ID that is associated with the downlink traffic (e.g., when no v-context ID has been provided by the PSA). The SMF may use the contact address that was part of the DL packet (provided by the UPF) to determine a v-context ID. The SMF may provide the obtained or determined v-context ID to the VCMF when sending the NIRR.

In certain representative embodiments, a VCMF (or any suitable network entity) may send a registration request to gNBs where the sponsored WTRUs may be located (e.g., based on a defined time slot, area of interest, or association with a sponsoring S-NSSAI). The VCMF may issue a NIRR message towards gNBs associated with an area of interest. The VCMF may update gNBs with information regarding NIR capabilities during a next generation set up procedure (e.g., N2 set up procedure).

Cellular services may be sponsored for non-registered WTRUs. In certain representative embodiments, third-party entities (e.g., an ASP or a calling party) intending to reach an unregistered WTRU may sponsor an unregistered WTRU to avail of services in a cellular network, (e.g., a 6G Network). Third party entities may assume the cost of such services (i.e., be charged for those services).

In certain representative embodiments, an ASP may be configured to sponsor cellular services. An ASP may request that an MNO sponsors services for one or more unregistered WTRUs. Services may range from full data connectivity with a specific QoS, mobile originated (MO) only data, or mobile terminated (MT) only data.

In certain representative embodiments, if a service sponsoring request is specifically made for unregistered WTRUs, an ASP provides a way for the network to reach these WTRUs securely. To this effect, the ASP may provide one or more application identifier(s), an area of interest where the unregistered WTRU may be located, a service scope the ASP is willing to sponsor (i.e., MT data, MO data, or both MT data and MO data), a reachability schedule (e.g., absolute time and time tolerance range), or security credentials with an option validity of these credentials.

In certain representative embodiments, an ASP may provide a v-session specific sponsoring identifier. For example, the ASP may provide a sponsoring generic public subscription identifier (GPSI), a SUPI, a mobile directory number, a permanent identifier, a static IP address such as an IPv4 address or a IPv6 prefix, a MAC address, a MAC address range, FQDN, or FQDN range. The ASP may provide a PDU session-less S-NSSAI/DNN associated with the one or more unregistered WTRUs or one or more network instance IDs (e.g., to enable a UPF to detect packets from certain IP domains or to forward packets to a peer node belonging to a certain IP domain).

In certain representative embodiments, if a sponsoring request is accepted, a VCMF generates a v-context reference ID. The v-context reference ID is used to store the v-context data in the UDR and to pass the data to the requesting ASP upon the sponsoring request response. The v-context may be stored at a UDM or UDR and may be fetched subsequently by a VCMF (e.g., a VCMF logically implemented as a standalone function or within a network entity such as a network exposure function (NEF), PCF, or any other suitable network entity which includes context information using the v-context reference ID). The ASP may use the v-context ID to retrieve the v-context context data from a UDR when a sponsoring procedure is requested.

In certain representative embodiments, a VCMF may offer to register unregistered WTRUs as an exposed service for other NFs including non-sponsored services. That is, the VCMF may be triggered to perform an NIR for an unregistered WTRU either by itself (e.g., when V-context data is updated) or when it receives a request from another NF (e.g., an SMF that has detected traffic for an unregistered WTRUs during an emergency).

In certain representative embodiments, an ASP which entered into an agreement with a MNO, determines to request sponsoring services through an AF. Alternatively, the ASP may offer (e.g., through a portal) a way for a third-party user to sponsor another user of the same application. For example, a user of a gaming application may be willing to pay for connectivity services to play with another user of the gaming application. As per a service level agreement (SLA), it may be possible that the ASP already provided configuration parameters to an MNO (e.g., application identifiers, WTRU identifiers associated with the application the ASP sponsors, or area of interest and sponsoring thresholds such as data volume, time or service credit based on the SLA). An ASP may determine a suitable VCMF based on one or more WTRU identifiers via a network entity (e.g., from an NEF or an NRF). Different VCMFs may maintain distinct v-contexts for different WTRUs. Hence, for each WTRU, a suitable VCMF be selected.

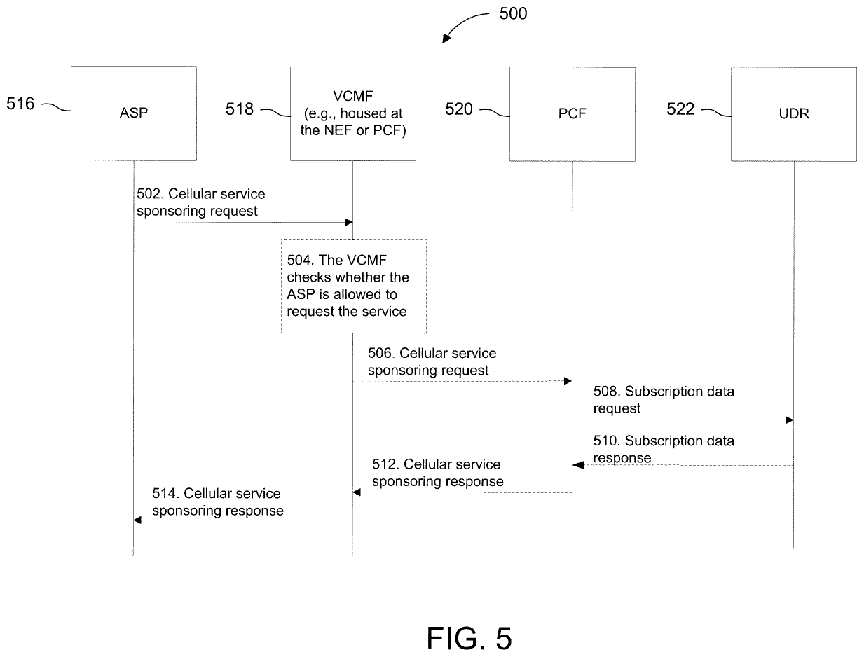

FIG. 5 is a diagram of illustrative steps for a service sponsoring request triggered by an ASP, according to one or more embodiments of this disclosure.

In diagram 500, at 502, ASP 516 issues a sponsoring request message and provides the v-context ID (if already provided by VCMF 518) with associated sponsoring data. For example, sponsoring data may include an application identifier, an area of interest where the unregistered WTRU may be located, a service scope, a reachability schedule, security credentials with an optional credential validity, a sponsoring ID, a static IP address, a MAC addresses, an FQDN, FQDN ranges, S-NSSAI/DNN information, or network instance information. The ASP may provide IP addresses of calling party subscribers (i.e., the originating IP address of calling party) which may generate traffic for non-registered WTRUs. The sponsoring request message may include an identifier for each WTRU. The identifier of each WTRU may be a SUPI or a permanent equipment identifier (PEI). The sponsoring request message may provide contact identifiers that can be used to reach unregistered WTRUs.

At 504, VCMF 518 checks whether AF 516 is allowed to request service (e.g., based on the SLA in place) and whether a given request is an initial request or an update. VCMF 518 may utilize information received from other network entities (e.g., a PCF or a charging function (CHF)) to validate SLAs based on MNO policies or traffic quota calculations. If the ASP provided the v-context ID, then the request is an update. As such, VCMF 518 may use the v-context ID and additional parameters to update the sponsoring context accordingly.

At 506, VCMF 518 may alternatively forward the sponsoring request to PCF 520. VCMF 518 may provide the v-context ID and any sponsoring parameters received at 504. PCF 520 checks if the request may be authorized (e.g., based on MNO policies) and whether additional sponsoring data is available (e.g., sponsoring policies such as PDRs and FARs).

At 508 and at 510, PCF 520 may obtain subscription data information which is associated with the v-context ID from the UDM or UDR 522. The data retrieved from the UDM or UDR 522 may be the sponsored data connectivity profile associated with the v-context ID.

At 512 and at 514, VCMF 518 (or alternatively PCF 520) sends a sponsoring response to AF 516 and indicates whether the sponsoring request has been granted. If the sponsoring request has been granted VCMF 518 provides the v-context ID that AF 516 may use for further request for a particular v-context.

In certain representative embodiments, if the sponsoring request involves multiple WTRUs, VCMF 518 may provide a v-context ID for each sponsored WTRU for which a sponsoring request was granted.

In certain representative embodiments, VCMF 518 may be configured to trigger selection and configuration of an SMF and/or PSA UPF. For example, VCMF 518 may select an SMF to serve a sponsored/unregistered WTRU. VCMF 518 may select the SMF based on the SUPI, mobile directory number, or other permanent identifier. For example, certain SMFs may be allocated to server WTRUs that are associated with certain MNOs or device manufacturers. VCMP 518 may select the SMF based on the contact address of the sponsored and unregistered WTRUs. Certain SMFs may be allocated to service specific IP address ranges or session initiation protocol (SIP) uniform resource identifiers (URIs). VCMF 518 may configure the SMF with information from the WTRU's context. The SMF may then select a PSA UPF to serve the WTRU. Selection of the PSA UPF may be based on the WTRU's contact information. The SMF may then configure the UPF to notify the SMF when downlink data is directed for the WTRU is detected.

A calling party may sponsor cellular services. In certain representative embodiments, a calling party WTRU (i.e., a WTRU that supports subscriber initiated sponsoring) establishes a PDU session using a sponsoring S-NSSAI and a sponsoring DNN. The SMF identifies the sponsoring request based on the DNN and S-NSSAI provided by the calling party WTRU and initiates PDU session authentication and sponsoring procedures. During the sponsoring configuration procedure, the calling party WTRU provides details of the WTRUs (the subscribers) it intends to sponsor (e.g., the WTRU provides an application ID and the directory number of the WTRUs which the calling-party WTRU intends to sponsor). Alternatively, or in addition, the calling party WTRU may provide identifiers of WTRUs it intends to sponsor. For example, the calling-party WTRU may provide FQDNs of the WTRUs that it wants to sponsor, or user IDs linked to the application associated with the application ID also provided. The DNN and S-NSSAI provided by the calling party WTRU may prompt the DNN to establish a connection to a VCMF.

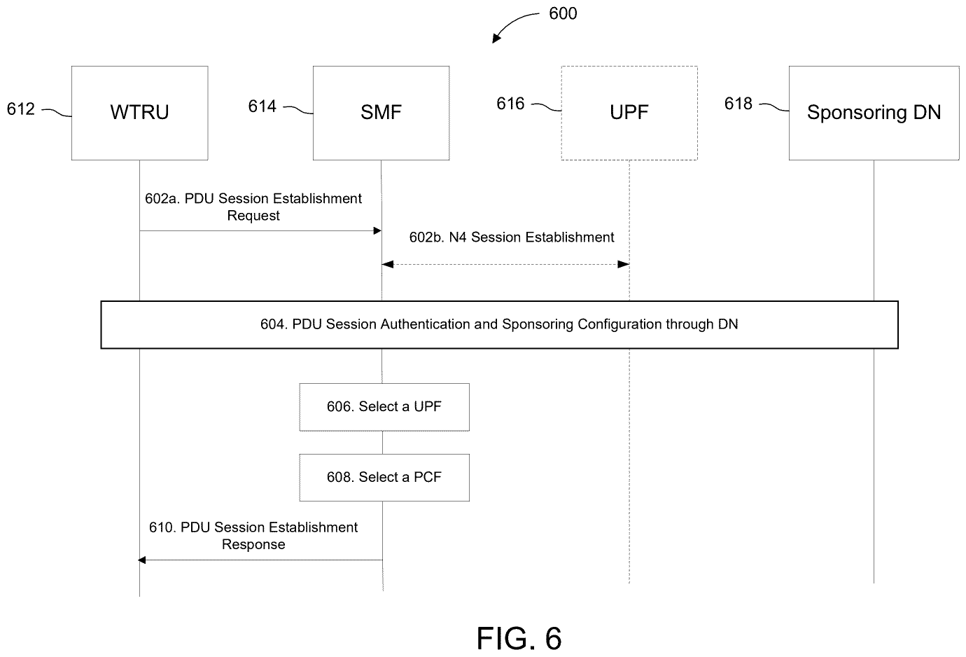

FIG. 6 is a diagram of illustrative steps for a calling party initiated sponsor request procedure, according to one or more embodiments of this disclosure.

In diagram 600, at 602a, calling party WTRU 612 intends to sponsor one or more WTRUs and requests the establishment, modification, or release of a PDU session. Calling party WTRU 612 uses a sponsoring S-NSSAI and a sponsoring DNN to request the PDU session establishment. It is to be understood that reference to WTRU 612 may be in reference to any of suitable WTRUs 102a-102d. Calling party WTRU 612 may use an NAS message (e.g., a PDU session modification request or a PDU session release request) to withdraw sponsoring from certain WTRUs previously sponsored.

At 602b, if SMF 614, optionally, chooses to utilize UPF 616 to contact the DN-authentication, authorization, and accounting (AAA) server (e.g., DN 618) and a VCMF, then SMF 614 establishes an N4 session. It is to be understood that reference to SMF 614 may be in reference to any suitable SMF 183a-183b. It is to be understood that reference to UPF 616 may be in reference to any suitable UPF 184a-184b.

At 604, during the PDU session authentication and sponsoring configuration procedure, calling party WTRU 612 configures a VCMF with information regarding the WTRUs calling party WTRU 612 intends to sponsor by providing identifiers of the WTRUs it intends to sponsor (e.g., GPSIs or directory numbers). Calling party WTRU 612 also provides authentication credentials that enable a VCMF to authenticate the sponsoring request.

At 606 and at 608, SMF 614, based on the S-NSSAI and DNN, select the UPF (e.g., UPF 616) and the PCF which calling party WTRU 612 is to use when contacting sponsored WTRUs. SMF 614 may provide details of the sponsoring request to the PCF and enable the PCF to use policies to control the sponsoring procedure. For example, the PCF may determine, based on MNO policies, whether calling party WTRU 612 may contact the VCMF directly or through an ASP. The PCF may provide calling-party WTRU 612 with URSP rules to route UL traffic to PDU sessions used for sponsored WTRUs. In addition, the PCF configures PDRs and FARs associated with a network instance and area of interest along with S-NSSAIs configured for the sponsored WTRUs.

At 610, SMF 614 sends a PDU session establishment response which includes a v-context ID and identifiers of the WTRUs that can be sponsored. The PDU session establishment response may further include FQDN or IP address information of the VCMF for calling-party WTRU 612 to use should calling party WTRU 612 use an ASP based sponsoring procedure. SMF 614 may provide URSP rules (from the PCF) calling party WTRU 612 uses to route UL traffic for sponsored WTRUs. Calling party WTRU 612 stores the v-context ID and associates the v-context ID with the PDU session ID selected for the PDU session just established.

In certain representative embodiments, a calling-party WTRU communicates with a network entity using (e.g., an SMF) NIR, the WTRU may protect the NAS message sent to the network entity (e.g., PDU Session Establishment request) using configured key material associated with its local V-context information.

In certain representative embodiments, calling-party WTRU 612 communicates with a network entity via an (e.g., SMF 614) NIR. Calling-party WTRU 612 may secure the NAS message (e.g., a PDU session establishment request) sent to the network entity using configured key materials associated with its local v-context information. The key material (e.g., security credentials) may be pre-provisioned by an AF. The key material may be configured by a network entity during a WTRU registration procedure. A WTRU may be configured with different key material on a per PLMN basis. That is, the WTRU may use configured key material associated with a serving PLMN where the NIR is taking place.

In certain representative embodiments, when calling party WTRU 612 sends an NAS message in response to an NIR (e.g., PDU session establishment), it includes a v-context ID. The v-context ID may be constructed to enable a network entity (e.g., RAN, SMF or other NF) to route data to the proper VCMF. For example, if a VCMF is located in the home network, the v-context ID may be in the form of a network access identifier (NAI). An NAI may include at least one of PLMN ID information or routing information (a routing ID) to a particular VCMF. For example, such information may include a unique ID associated with a particular WTRU and the corresponding routing information. A WTRU may use the key material or security keys derived from the key material to secure an NAS message or portion thereof (e.g., for confidentiality or integrity purposes). A WTRU may derive security keys based on the security credentials or a freshness parameter sent in the NAS message. For example, the NAS message (e.g., which is protected) may include a v-context ID and additional security parameters (e.g., a freshness parameter specifying nonce) used to derive new keys used to protect the message and its content. A WTRU may include a container (e.g., a virtual context management container (VCM container)) protected inside the NAS message. The context ID and parameters needed for routing to the proper VCMF for securely processing the message may be included in the NAS message. A container may be encrypted to protect sensitive data (e.g., S-NSSAI or DNN).

When receiving the message request from a WTRU (e.g., calling party WTRU 612), the NF (e.g., SMF 614) determines whether the message is for an NIR procedure based on a particular v-context ID. Based on the v-context ID, a WTRU may forward the request message to the proper VCMF for security processing. When receiving the request, the VCMF locates the v-context associated with the WTRU based on the v-context ID. The VCMF may derive security keys similarly to a WTRU (e.g., as previously described above) using a freshness parameter or key material from the local v-context.

In certain representative embodiments, a VCMF may send a response to the NF that includes processed content (e.g., decrypted container content) if security verification is successful and if the WTRU is authorized to perform communications using NIR. A VCMF may send a rejection response indicating a WTRU is not authorized for NIR based communications. The response may include a new v-context ID to be passed to the WTRU (e.g., inside a VCM container). The new v-context ID is used in the VCMF to locate the new v-context (instead of the previous v-context ID). A network entity (e.g., SMF 614) sends a response (e.g., PDU session establishment response) to a WTRU (e.g., calling party WTRU 612). The response may include the (e.g., securely) protected v-context ID. A WTRU (e.g., calling party WTRU 612) stores the new v-context ID associated with the PLMN and replaces the previously stored v-context ID. Hence, a WTRU (e.g., calling party WTRU) may utilize the new v-context ID during a subsequent NIR based communication session to prevent potential tracking of the WTRU based on the previous v-context ID.

In certain representative embodiments, calling-party WTRU 612 may use the v-context ID when attempting to reach (i.e., establish data connectivity) sponsored WTRUs (e.g., if the PDU session originally used to configure the v-context no longer exists) via DN 618. It is to be understood that reference to DN 618 may be in reference to any suitable DN 185a-185b. If no previous sponsoring PDU session exists, calling party WTRU 612 uses the v-context ID when establishing a new sponsoring PDU session to SMF 614 to retrieve the v-context without the need for calling party WTRU 612 to send v-context data again.

Certain events in a cellular system (e.g., a 6G cellular system) may prompt or trigger an NIR procedure. For example, the wireless network receiving DL data may trigger an NIR procedure. In certain representative embodiments, a PSA includes DL data such that the PSA been configured with sponsoring data (i.e., it has been configured with PDRs and FARs that enable the UPF to detect traffic for unregistered WTRUs). The PSA notifies the SMF, and the SMF triggers a NIRR for the VCMF. The NIRR may provide the v-context ID and the application ID. Hence, the VCMF may identify the WTRUs that need to be registered, the available time slots for possible reachability, and the area of interest where the WTRUs which need to be registered may be located.

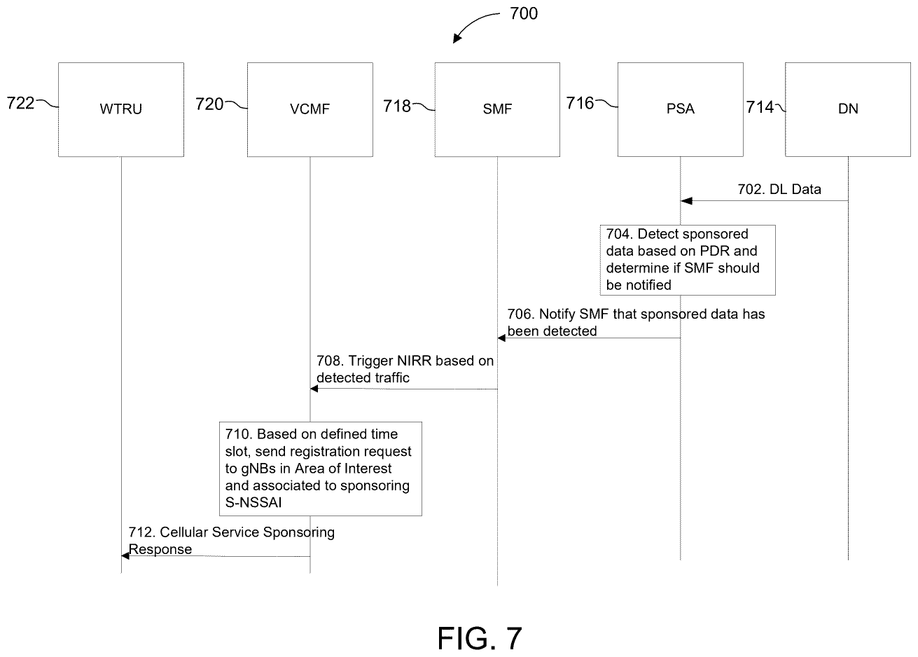

FIG. 7 is a diagram of illustrative steps for a registration procedure triggered by a network entity receiving downlink data, according to one or more embodiments of this disclosure.

In diagram 700, at 702, PSA 716 receives DL data from DN 714 for unregistered/sponsored WTRUs. It is to be understood that reference to DN 714 may be in reference to any suitable DN 185a-185b or 618.

At 704, PSA 716, using relevant PDRs, detects traffic intended for unregistered sponsored WTRUs. For example, PSA 716 may detect at least one of a destination IP address, network instance, application ID, or originating IP address. PSA 716 determines whether SMF 718 should be notified (e.g., based on the action rule from the FAR). It is to be understood that reference to SMF 718 may be in reference to any suitable SMF 183a-183b or 614. PSA 716 may determine a v-context ID that is associated with the downlink traffic, and the determination by PSA 716 may be based on configuration information that was received from SMF 718 (e.g., the set of PDRs). SMF 718 may configure a UPF with information (e.g., PDRs) that may be used to map a contact address that is in a DL packet to a v-context ID. Alternatively, the v-context ID may be configured as a part of an FAR associated with a PDR configured to identify sponsored traffic.

At 706, PSA 716 informs SMF 718 that sponsored traffic has been identified. PSA 716 provides parameters that caused the traffic to be identified. PSA 716 may inform SMF 718 of the v-context ID if necessary.

At 708, SMF 718, based on MNO policies and parameters identified by PSA 716, determines that a NIR is warranted. SMF 718 issues an NIRR for VCMF 720. It is to be understood that reference to VCMF 720 may be in reference to any suitable VCMF 190 or 518. SMF 718 may determine the appropriate VCMF (e.g., VCMF 720). SMF 718 may determine the appropriate VCMF by using the v-context ID and/or application ID and by querying an NRF. If no v-context ID has been provided by PSA 716, SMF 718 may determine v-context ID that is associated with the downlink traffic. The UPF may provide a contact address that was part of the DL packet to SMF 718, and SMF 718 may use the contact address to determine a v-context ID. SMF 718 provides the obtained or determined v-context ID to VCMF 720 when sending the NIRR.

At 710, VCMF 720, based on at least one of a defined time slot, area of interest, or association to the sponsoring S-NSSAI, sends a registration request to gNBs where the unregistered sponsored WTRUs may be located.

At 712, VCMF 720 issues an NIRR message towards gNBs associated with an area of interest to WTRU 722. It is to be understood that reference to WTRU 722 may be in reference to any of suitable WTRUs 102a-102d or 614. During an NG setup procedure (e.g., N2 set up procedure), a CN (e.g., CN 106 or 115) may update gNBs with information regarding NIR capabilities.

In certain representative embodiments, an ASP may use VCMF APIs (e.g., of VCMF 720) that expose NIR services, and the ASP issues an NIRR towards the VCMF to register an unregistered/sponsored WTRUs. Hence, the ASP is enabled to establish data connectivity for the unregistered/sponsored WTRUs. The ASP may use the v-context ID and application ID to request the NIR from the VCMF.

In certain representative embodiments, a calling party WTRU may contact a VCMF to trigger an NIR for unregistered sponsored WTRUs. The calling party WTRU may be enabled to establish data connectivity with unregistered sponsored WTRUs. The calling party WTRU may use the v-context ID and application ID to request the NIR from the VCMF.

As described above, calling party WTRU may contact a VCMF to trigger an NIR using a NAS message (e.g., a PDU session establishment request, PDU session modification request, or PDU session release request).

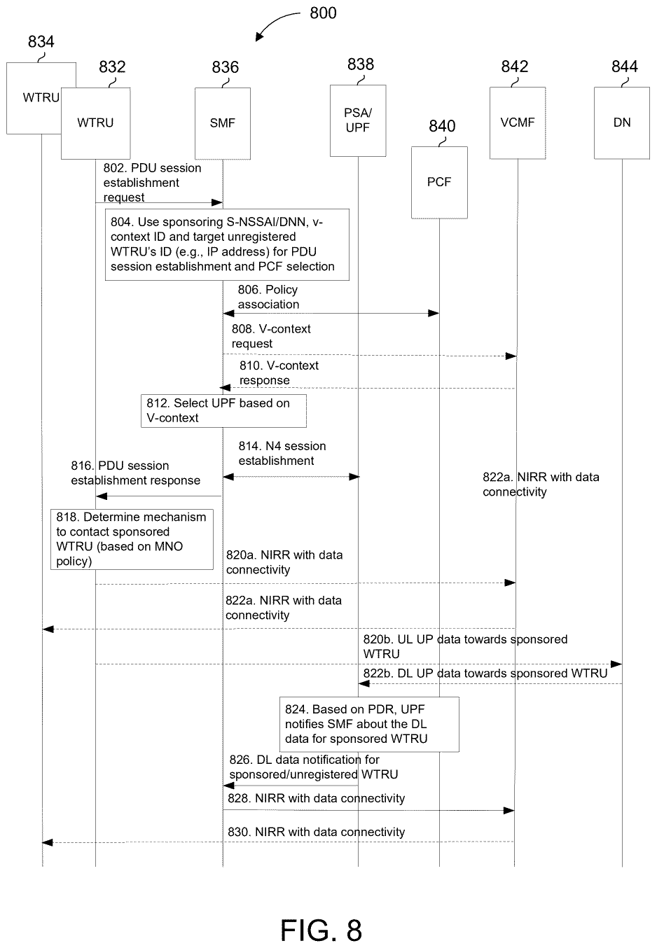

FIG. 8 is a diagram of illustrative steps for a registration procedure triggered by a calling party, according to one or more embodiments of this disclosure.

In diagram 800, at 802, calling party WTRU 832 requests a PDU session establishment procedure. Calling party WTRU 832 provides a sponsoring S-NSSAI or DNN and v-context ID. SMF 836 and UPF 838 may be enabled to, respectively, select and configure S-NSSAI or DNN and v-context ID data for sponsored traffic. It is to be understood that reference to calling party WTRU 832 may be in reference to any one of suitable WTRUs 102a-102d, 614, or 722. It is to be understood that reference to UPF 838 may be in reference to any suitable UPF 184a-184b or 616. It is to be understood that reference to SMF 836 may be in reference to any one of suitable SMFs 183a-183, 614, or 718.

At 804, SMF 836 uses at least one of sponsoring S-NSSAI or DNN, v-context ID, target unregistered WTRU IDs (e.g., an IP address for WTRU 834), mobile directory number, or GPSI for PDU session establishment and PCF selection. For example, SMF 836 may select a PCF (e.g., PCF 840) that is configured to manage policies for either sponsored or unregistered WTRUs (e.g., calling party WTRU 832 or WTRU 834). It is to be understood that reference to WTRU 834 may be in reference to any of one of suitable WTRUs 102a-102d, 614, or 722. It is to be understood that reference to PCF 840 may be in reference to PCF 520.

At 806, SMF 836 establishes a policy association with PCF 840 (or any other suitable PCF which SMF 836 selects). SMF 836 obtains policies and rules to enable itself to configure at least one of URSP rules, PDRs, or FARs.

At 808, SMF 836 may request v-context data. SMF 836 may request v-context data using the v-context ID provided by calling party WTRU 832.

At 810, VCMF 842 provides the v-context associated with the v-context ID provided by SMF 836. It is to be understood that reference to VCMF 842 may be in reference to any one of suitable VCMFs 190, 518, or 720.

At 812, SMF 836 selects UPF 838 (or any other suitable UPF) based on the v-context, S-NSSA or DNN, and policies provided by PCF 840. For example, SMF 836 may select UPF 840 using the network instance specified in the v-context.

At 814, SMF 836 establishes an N4 session. SMF 836 may configure UPF 838 with a particular PDR and FAR specified in the v-context.

At 816, SMF 836 sends a PDU session establishment response to calling party WTRU 834. The PDU session establishment response may include URSP rules and policies that enable calling party WTRU 834 to route traffic intended for a sponsored WTRU (e.g., WTRU 834) associated with the v-context, S-NSSAI, or DNN. SMF 836 may provide the FQDN or IP address of VCMF 842 (or any other suitable VCMF) which initiated a registration procedure for a WTRU (e.g., WTRU 834) specified in the v-context.

At 818, calling party WTRU 832 uses policies and URSP rules to the determine a relevant NIR request mechanism. For example, calling party WTRU 832 may select a direct or an indirect NIR request mechanism. If an indirect mechanism is selected to route traffic intended for a given WTRU, a PDU session is set up for that specific purpose.

At 820a, calling party WTRU 832 may use VCMF 842 to request an NIR for one or more WTRUs to be sponsored or registered (e.g., WTRU 834). Calling party WTRU 820a may provide a v-context ID to enable VCMF 842 to identify which WTRUs (e.g., WTRU 834) need to be sponsored or registered.

At 822a, VCMF 842 issues an NIRR message. The NIRR message may be based on a v-context. For example, the v-context may specify a particular area of interest or timing information.

At 820b and 822b, calling party WTRU 832 uses the unregistered WTRU ID (e.g., WTRU 834) to send UL data towards the unregistered WTRU (e.g., WTRU 834) via DN 844. For example, data may include a static IP address, FQDN or a mobile directory number. It is to be understood that reference to DN 844 may be in reference to any one of suitable DNs 185a-185b, 618, or 714.

At 824, the UPF 834 uses a PDR to detect traffic for an unregistered WTRU (e.g., WTRU 834).

At 826, when a match is detected upon receiving DL data, UPF 838 buffers the received DL data and informs SMF 836 of such an event (e.g., via a DL data notification procedure) by providing details of matching traffic. For example, details may include at least one of an originating IP address, terminating IP address, or v-context ID.

At 828, SMF 836 triggers an NIRR procedure for VCMF 842. SMF 836 may provide the v-context ID.

At 830, VCMF 842, based on the v-context, triggers a network-initiated procedure for an unregistered WTRU. VCMF 842 issues an NIRR message. The NIRR message may include information specified in a v-context such as a specific are of interest or timing information.

In certain representative embodiments, WTRU 834 may receive the NIRR message from 830 may accept or reject the NIRR (e.g., based on the originating IP address and v-context ID received in the NIRR message). Furthermore, WTRU 834 may trigger security procedures to authenticate the NIRR.

In certain representative embodiments, WTRU 834 may transmit an NIRR, indicating whether the NIRR was accepted. WTRU 834 may use a WTRU initiated registration request as a response to the NIRR from 830.

In certain representative embodiments, when SMF 836 receives an NIRR, it may transmit an NAS message (e.g., network initiated PDU session establishment request) with an indication indicating that the PDU session establishment request corresponds to a sponsored PDU session by including a v-context ID. WTRU 834 may accept the sponsored PDU session establishment request. WTRU 834 may transmit an NAS message (e.g., PDU establishment request) to communicate the acceptance of the sponsored connectivity request. SMF 836 may transmit a PFCP message to PSA 838 requesting the delivery of the buffered DL data (e.g., as previously described above).

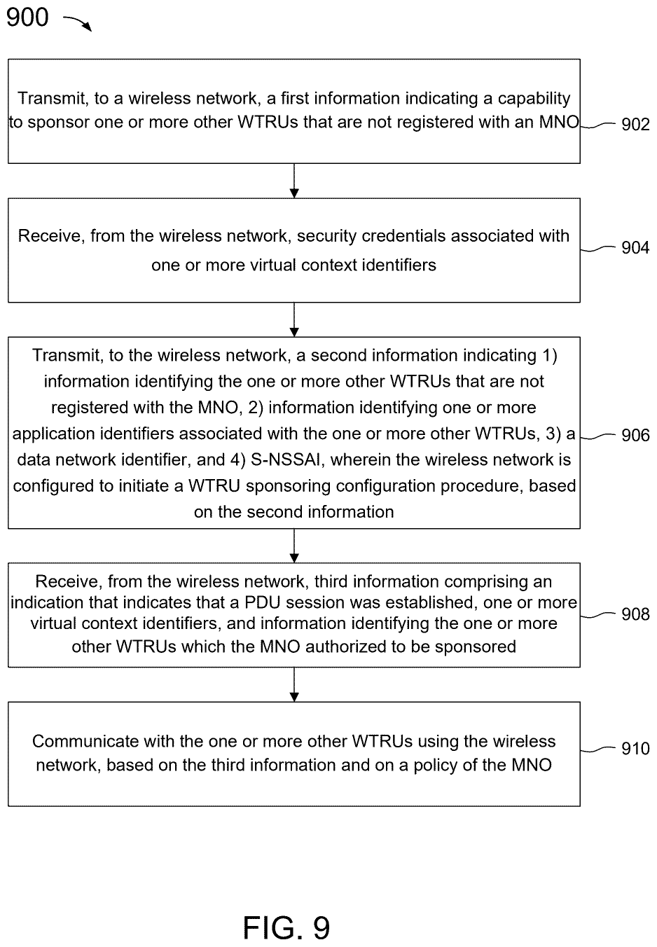

FIG. 9 is a flowchart of illustrative steps for a service sponsorship procedure initiated by a calling party for one or more WTRUs which are not registered with a particular MNO, according to one or more embodiments of this disclosure.

At 902, a WTRU (which may be in reference to any one of suitable WTRUs mentioned in FIGS. 1A, 1C, 1D, 6, 7, or 8) transmits, to a wireless network, a first information indicating a capability to sponsor one or more other WTRUs that are not registered with an MNO.

At 904, the WTRU receives, from the wireless network, security credentials associated with one or more virtual context identifiers.

At 906, the WTRU transmits, to the wireless network, a second information indicating identifying the one or more other WTRUs that are not registered with the MNO, information identifying one or more application identifiers associated with the one or more other WTRU, a data network identifier, and S-NSSAI. The wireless network is configured to initiate a WTRU sponsoring configuration procedure, based on the second information.

In certain representative embodiments, second information includes any of: a general public subscription identifier (GPSI), a fully qualified domain name (FQDN), or a directory number.

In certain representative embodiments, the second information indicates virtual context information associated with a context identifier, the virtual context information including one or more of information identifying the WTRU, information identifying the one or more other WTRUs, information identifying the one or more application identifiers associated with the other WTRUs, MNO information regarding available credit, MNO information regarding allowed data volume, MNO information regarding available service time, or MNO information regarding an area of interest.

In certain representative embodiments, the WTRU is further configured to determine that the PDU session no longer exists and transmit a second indication to utilize the one or more virtual context identifiers to the wireless network, wherein the wireless network is configured to establish a new PDU session based at least in part on the one or more virtual context identifiers.

In certain representative embodiments, the WTRU is further configured to transmit authentication credentials to the wireless network, wherein the authentication credentials indicate to the wireless network to initiate registration of the one or more other WTRUs

At 908, the WTRU receives, from the wireless network, third information including an indication that indicates that a PDU session was established, one or more virtual context identifiers, and information identifying the one or more other WTRUs which the MNO authorized to be sponsored.

In certain representative embodiments, when receiving the third information comprising the indication that indicates that the PDU session was established, the WTRU is further configured to receive at least one of URSP rules or information corresponding to a VCMF. The information corresponding to the VCMF includes at least one of a FQDN or an IP address. The VCMF manages virtual context information.

At 910, the WTRU communicates with the one or more other WTRUs using the wireless network, based on the third information and on a policy of the MNO.

In certain representative embodiments, the policy of the MNO includes a second indication of whether the WTRU is configured to support at least one of: triggering a network initiated registration procedure via a virtual context management function (VCMF) or triggering a network initiated registration procedure by directly addressing any of the one or more other WTRUs.

In certain representative embodiments, the WTRU is further configured to transmit a virtual context identifier corresponding to a virtual context to the wireless network comprising at least one of a SUPI, GPSI, mobile directory number, IP address, FQDN, or MAC address corresponding to the WTRU.

In certain representative embodiments, the MNO policy comprises information indicative of whether the WTRU may transmit and receive information to and from a VCMF or whether an application service provider is required.

In certain representative embodiments, the policy of the MNO comprises incurring a cost associated with communication between the WTRU and the one or more other WTRUs.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU), the method comprising:
transmitting, to a wireless network, first information indicating a capability to sponsor one or more other WTRUs that are not registered with a mobile operator network (MNO);
receiving, from the wireless network, security credentials associated with one or more virtual context identifiers;
transmitting, to the wireless network, second information indicating:
1) information identifying the one or more other WTRUs that are not registered with the MNO,
2) information identifying one or more application identifiers associated with the one or more other WTRUs,
3) a data network identifier, and
4) single-network slice selection assistance information (S-NSSAI),
wherein the wireless network is configured to initiate a WTRU sponsoring configuration procedure, based on the second information;
receiving, from the wireless network, third information comprising an indication that indicates that a packet data unit (PDU) session was established, the one or more virtual context identifiers, and information identifying one or more other WTRUs which the MNO authorized to be sponsored; and
communicating with the one or more other WTRUs using the wireless network, based on the third information and on a policy of the MNO.

2. The method of claim 1, wherein the second information further indicates any of: a general public subscription identifier (GPSI), a fully qualified domain name (FQDN), or a directory number.

3. The method of claim 1, wherein the second information further indicates virtual context information associated with a context identifier, the virtual context information comprising one or more of information identifying the WTRU, information identifying the one or more other WTRUs, information identifying the one or more application identifiers associated with the other WTRUs, MNO information regarding available credit, MNO information regarding allowed data volume, MNO information regarding available service time, or MNO information regarding an area of interest.

4. The method of claim 3, further comprising:
determining that the PDU session no longer exists; and
transmitting a second indication to utilize the one or more virtual context identifiers to the wireless network, wherein the wireless network is configured to establish a new PDU session based at least in part on the one or more virtual context identifiers.

5. The method of claim 1, wherein the policy of the MNO comprises a second indication of whether the WTRU is configured to support at least one of: triggering a network initiated registration procedure via a virtual-context management function (VCMF) or triggering a network initiated registration procedure by directly addressing any of the one or more other WTRUs.

6. The method of claim 1, further comprising:
transmitting a virtual context identifier corresponding to a virtual context to the wireless network comprising at least one of a subscription permanent identifier (SUPI), general public subscription identifier (GPSI), mobile directory number, internet protocol (IP) address, fully qualified domain name (FQDN), or media access control (MAC) address corresponding to the WTRU.

7. The method of claim 1, when receiving the third information comprising the indication that indicates that the PDU session was established further comprises:
receiving at least one of user equipment route selection policy (URSP) rules or information corresponding to a virtual-context management function (VCMF), wherein:
the information corresponding to the VCMF comprises at least one of a fully qualified domain name (FQDN) or an internet protocol (IP) address, and
the VCMF manages the one or more virtual context identifiers.

8. The method of claim 1, further comprising:
transmitting authentication credentials to the wireless network, wherein the authentication credentials indicate to the wireless network to initiate registration of the one or more other WTRUs.

9. The method of claim 1, wherein the MNO policy comprises information indicative of whether the WTRU may transmit and receive information to and from a virtual context management function (VCMF) or whether an application service provider is required.

10. The method of claim 1, wherein the policy of the MNO comprises incurring a cost associated with communication between the WTRU and the one or more other WTRUs.

11. A wireless transmit/receive unit (WTRU) comprising:
a processor; and
a transceiver, wherein the WTRU is configured to:
transmit, to a wireless network, first information indicating a capability to sponsor one or more other WTRUs that are not registered with a mobile operator network (MNO);
receive, from the wireless network, security credentials associated with one or more virtual context identifiers;
transmit, to the wireless network, second information indicating:
1) information identifying the one or more other WTRUs that are not registered with the MNO,
2) information identifying one or more application identifiers associated with the one or more other WTRUs,
3) a data network identifier, and
4) single-network slice selection assistance information (S-NSSAI),
wherein the wireless network is configured to initiate a WTRU sponsoring configuration procedure, based on the second information;
receive, from the wireless network, third information comprising an indication that indicates that a packet data unit (PDU) session was established, one or more virtual context identifiers, and information identifying one or more other WTRUs which the MNO authorized to be sponsored; and
communicate with the one or more other WTRUs using the wireless network, based on the third information and on a policy of the MNO.

12. The WTRU of claim 11, wherein the second information comprises any of: a general public subscription identifier (GPSI), a fully qualified domain name (FQDN), or a directory number.

13. The WTRU of claim 11, wherein the second information indicates virtual context information associated with a context identifier, the virtual context information comprising one or more of information identifying the WTRU, information identifying the one or more other WTRUs, information identifying the one or more application identifiers associated with the other WTRUs, MNO information regarding available credit, MNO information regarding allowed data volume, MNO information regarding available service time, or MNO information regarding an area of interest.

14. The WTRU of claim 13, further configured to:
determine that the PDU session no longer exists; and
transmit a second indication to utilize the one or more virtual context identifiers to the wireless network, wherein the wireless network is configured to establish a new PDU session based at least in part on the one or more virtual context identifiers.

15. The WTRU of claim 11, wherein the policy of the MNO comprises a second indication of whether the WTRU is configured to support at least one of: triggering a network initiated registration procedure via a virtual context management function (VCMF) or triggering a network initiated registration procedure by directly addressing any of the one or more other WTRUs.

16. The WTRU of claim 11, further configured to:
transmit a virtual context identifier corresponding to a virtual context to the wireless network comprising at least one of a subscription permanent identifier (SUPI), general public subscription identifier (GPSI), mobile directory number, internet protocol (IP) address, fully qualified domain name (FQDN), or media access control (MAC) address corresponding to the WTRU.

17. The WTRU of claim 11, wherein, when receiving the third information comprising the indication that indicates that the PDU session was established, the WTRU is further configured to:
receive at least one of user equipment route selection policy (URSP) rules or information corresponding to a virtual-context management function (VCMF), wherein:
the information corresponding to the VCMF comprises at least one of a fully qualified domain name (FQDN) or an internet protocol (IP) address, and
the VCMF manages the one or more virtual context identifiers.

18. The WTRU of claim 11, further configured to:
transmit authentication credentials to the wireless network, wherein the authentication credentials indicate to the wireless network to initiate registration of the one or more other WTRUs.

19. The WTRU of claim 11, wherein the MNO policy comprises information indicative of whether the WTRU may transmit and receive information to and from a virtual context management function (VCMF) or whether an application service provider is required.

20. The WTRU of claim 11, wherein the policy of the MNO comprises incurring a cost associated with communication between the WTRU and the one or more other WTRUs.
